(19) United States
(12) Patent Application Publication
(10) Pub. No.: US 2024/0107431 A1
(43) Pub. Date: Mar. 28, 2024

(54) SYSTEMS, METHODS, AND DEVICES FOR CHANNEL SCANNING IN WIRELESS DEVICES

(71) Applicant: Cypress Semiconductor Corporation, San Jose, CA (US)

(72) Inventors: Amit SHAW, Bangalore (IN); Ayush SOOD, Bengaluru (IN)

(73) Assignee: Cypress Semiconductor Corporation, San Jose, CA (US)

(21) Appl. No.: 17/955,335

(22) Filed: Sep. 28, 2022

(51) Int. Cl. H04W 48/16; H04L 5/00; H04W 48/14

(52) U.S. Cl. CPC H04W 48/16; H04L 5/0092; H04W 48/14

(57) ABSTRACT

Systems, methods, and devices implement channel scanning for establishing connections between wireless devices. Methods include selecting a first plurality of channels of a wireless device, the first plurality of channels being sub-bands of a wireless device, scanning the first plurality of channels for a transmission from an access point, the first plurality of channels being scanned in parallel, and selecting a second plurality of channels of the wireless device, the second plurality of channels being sub-bands of the wireless device. Methods further include scanning the second plurality of channels for the transmission from the access point, the second plurality of channels being scanned in parallel.

### TECHNICAL FIELD

This disclosure generally relates to wireless devices, and more specifically, to channel scanning modalities associated with such wireless devices.

### BACKGROUND

Wireless devices may communicate with each other via one or more communications modalities, such as a Wi-Fi connection and/or a Bluetooth connection. Accordingly, such wireless communication may be implemented in a manner compliant with a wireless communication protocol. Moreover, such wireless devices may be implemented in the context of one or more communications networks, and may perform network discovery and connection operations to connect to such networks. To establish such network connections, wireless devices, such as stations, may scan different channels for transmissions from other wireless devices, such as access points. Conventional techniques for performing such scanning operations remain limited because they may take large amounts of time for scanning operations in devices with multiple bands and many channels.

### BRIEF DESCRIPTION OF THE DRAWINGS

FIG. 1 illustrates an example of a system for channel scanning using wireless devices, configured in accordance with some embodiments.

FIG. 2 illustrates an example of a device for channel scanning, configured in accordance with some embodiments.

FIG. 3A illustrates an example of a timing diagram for channel scanning, implemented in accordance with some embodiments.

FIG. 3B illustrates an example of another timing diagram for channel scanning, implemented in accordance with some embodiments.

FIG. 3C illustrates an example of yet another timing diagram for channel scanning, implemented in accordance with some embodiments.

FIG. 4 illustrates an example of a method for channel scanning using wireless devices, implemented in accordance with some embodiments.

FIG. 5 illustrates an example of a method for channel scanning using wireless devices, implemented in accordance with some embodiments.

FIG. 6 illustrates an example of a method for channel scanning using wireless devices, implemented in accordance with some embodiments.

FIG. 7 illustrates an example of a timing diagram for active channel scanning, implemented in accordance with some embodiments.

FIG. 8 illustrates an example of another timing diagram for passive channel scanning, implemented in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may perform network discovery and connection operations to connect with each other and to facilitate network communications. For example, an access point may communicate with one or more stations to establish network connections with such stations. As will be discussed in greater detail below, stations may perform scanning operations to scan multiple channels to identify which channel should be used for communication with the access point. Conventional techniques for performing such scanning operations remain limited because they may take large amounts of time for scanning operations in devices with multiple bands and many channels. For example, a multi-band device may communicate on a 2.4 GHz band and a 5 GHz band and have multiple channels or sub-bands on each band representing a portion or partition of the bandwidth on that band. Conventional techniques for scanning such channels require large amounts of time to cycle through each of the channels and perform scanning operations on each channel. Accordingly, conventional techniques require large channel scan times to traverse the multiple channels.

Various embodiments disclosed herein provide the ability to scan multiple channels in parallel thus reducing scan times associated with network connection operations. More specifically, a wireless device, such as a station, may be configured to utilize a high-bandwidth mode to simultaneously scan multiple channels. In this way, a total scan time for the channels may be reduced as well as time associated with other operations, such as channel switching operations. As will be discussed in greater detail below, one or more components of the stations may be configured to perform such parallel scanning operations. Accordingly, multi-band devices, such as tri-band devices, that may have a 2.4 GHz band, a 5 GHz band, and a 6 GHz band, may be configured to greatly reduce total channel scan times when scanning for an access point. For example, passive scanning operations may experience a 75% reduction in scan time in, for example, an 80 MHz bandwidth device, and active scanning operations in such a device may experience a 50-75% reduction in scan time.

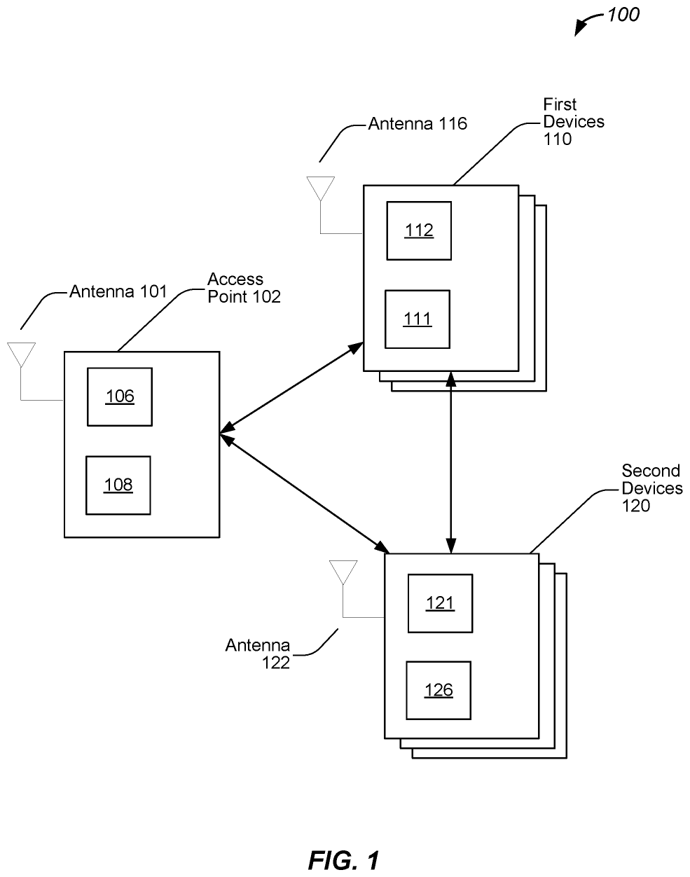

FIG. 1 illustrates an example of a system for channel scanning using wireless devices, configured in accordance with some embodiments. As shown in FIG. 1, various wireless devices may communicate with each other via one or more wireless communications media. For example, wireless devices may communicate with each other via a Wi-Fi connection and/or a Bluetooth connection. In various embodiments, the wireless devices may first establish connections or communications links before data transfer occurs. Once a communications link is established, packetized network traffic may be sent over a communications network. Accordingly, data packets may be sent and received between such wireless devices. As will be discussed in greater detail below, wireless devices disclosed herein and systems, such as system 100, that include such wireless devices are configured to perform channel scanning operations in parallel. In this way, such wireless devices may be configured to reduce scan times associated with such network discovery operations.

System 100 includes access point 102 which may be a wireless device configured to support wireless connections on multiple frequency bands and corresponding channels. For example, access point 102 may be configured to support concurrent wireless connections at 2.4 GHz and 5 GHz. Such bands may have 20 MHz channels. Accordingly, a 2.4 GHz band may have 13 or 14 20 MHz channels, and a 5 GHz band may have 25 20 MHz channels. In some embodiments, access point 102 may also support a 6 GHz band and be a tri-band device. The 6 GHz band may have 59 20 MHz channels or 24 20 MHz channels, depending on its configuration. Accordingly, access point 102 may include one or more transceivers, such as transceiver 106 and an associated processing device, such as processing device 108. Access point 102 may also include one or more antennas, such as antenna 101. In various embodiments, Access point 102 is compatible with one or more wireless transmission protocols, such as a Wi-Fi protocol and/or a Bluetooth protocol. In some embodiments, access point 102 may be implemented in the context of a system of devices, such as an infotainment system of a car. Accordingly, access point 102 may support multiple wireless connections with other wireless devices.

In various embodiments, system 100 additionally includes first devices 110 which may be wireless devices. As discussed above, such wireless devices may be compatible with one or more wireless transmission protocols, such as a Wi-Fi protocol and/or a Bluetooth protocol. In some embodiments, first devices 110 are mobile communications devices, such as smartphones. Moreover, such wireless devices may be smart devices, such as those found in wearable devices. It will be appreciated that, first devices 110 may be any suitable device, such as those found in cars, other vehicles, and even medical implants.

As shown in FIG. 1, various wireless devices may be in communication with each other via one or more wireless communications mediums. As shown in FIG. 1, first devices 110 may each include an antenna, such as antenna 116. First devices 110 may also include processing device 111 as well as transceiver 112. As will be discussed in greater detail below, such processing devices, transceivers, and radios may be configured to send and receive data packets between each other, and perform scanning operations for network discovery. More specifically, as will be discussed in greater detail below, first devices 110 may be configured to perform channel scanning operations in parallel and reduce scan times associated with such network discovery operations.

In some embodiments, system 100 may further include second devices 120 which may also be wireless devices. As similarly discussed above, second devices 120 may be compatible with one or more wireless transmission protocols, such as a Wi-Fi protocol and/or a Bluetooth protocol. Moreover, second devices 120 may be wireless devices such as smartphones. In some embodiments, second devices 120 may also be smart devices or other devices, such as IoT devices, devices found in cars, other vehicles, and medical implants. In various embodiments, second devices 120 may be different types of devices than first devices 110. As discussed above, each of second devices 120 may include an antenna, such as antenna 122, as well as processing device 126 and transceiver 121, which may also be configured to establish communications connections with other devices, and transmit and receive data in the form of data packets via such communications connections. Accordingly, as discussed above, second devices 120 may also be configured to perform channel scanning operations in parallel and reduce scan times associated with such network discovery operations.

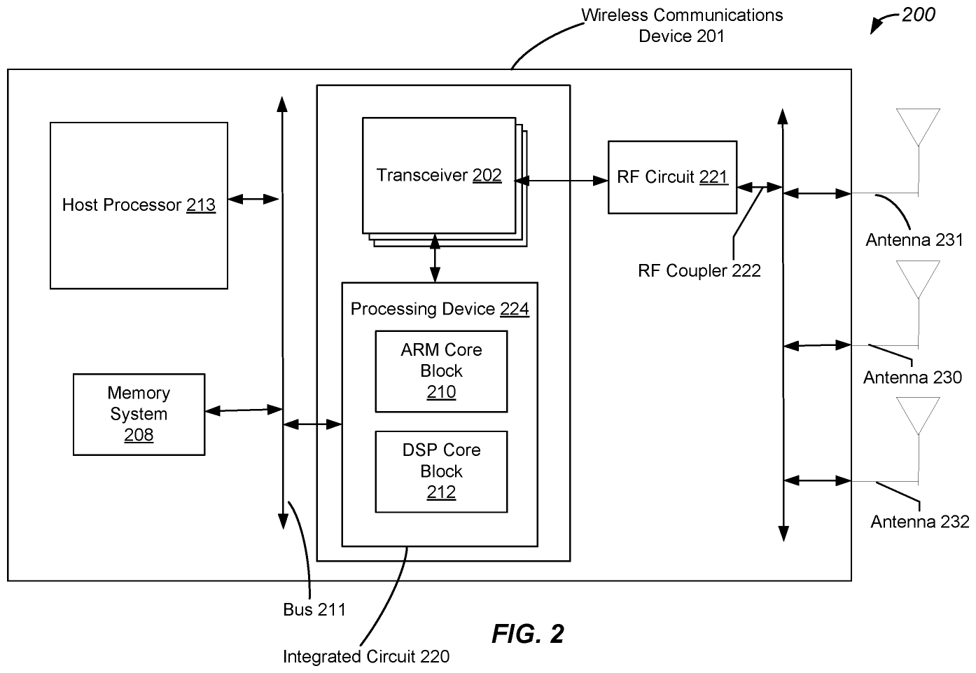

FIG. 2 illustrates an example of a device for channel scanning, configured in accordance with some embodiments. More specifically, FIG. 2 illustrates an example of a system, such as system 200, that may include wireless communications device 201. It will be appreciated that wireless communications device 201 may be one of any of first devices 110 or second devices 120 discussed above. In various embodiments, wireless communications device 201 includes a transceiver, such as transceiver 202, which may be a transceiver such as transceivers 112 and 121 discussed above. In one example, system 200 includes transceiver 202 which is configured to transmit and receive signals using a communications medium that may include antenna 231. As noted above, transceiver 202 may be included in a Bluetooth radio, and may be compatible with a Wi-Fi communications protocol. In various embodiments, transceiver 202 may be compatible with another communications protocol, such as a Bluetooth Low Energy protocol or a Zigbee protocol or any other suitable transmission protocol. Accordingly, transceiver 202 may include components, such as a modulator and demodulator as well as one or more buffers and filters, that are configured to generate and receive signals via antenna 231.

In various embodiments, system 200 further includes processing device 224 which may include logic implemented using one or more processor cores. Accordingly, processing device 224 is configured to facilitate parallel scanning operations across multiple frequency bands. In various embodiments, processing device 224 includes one or more components, such as firmware and/or processing elements, that are configured to implement such scanning operations. More specifically, processing device 224 includes one or more components configured to implement a medium access control (MAC) layer that is configured to control hardware associated with a wireless transmission medium, such as that associated with a Wi-Fi transmission medium. In one example, processing device 224 may include processor core block 210 that may be configured to implement a driver. Processing device 224 may further include digital signal processor (DSP) core block 212 which may be configured to include microcode. In various embodiments, processor core block 210 comprises multiple processor cores which are each configured to implement specific portions of a wireless protocol interface. For example, processor core block may be configured to implement portions of the baseband or physical (PHY) layer of the Wi-Fi interface as well as the MAC layer.

In various embodiments, wireless communications device 201 and processing device 224 are configured as high-bandwidth devices. Accordingly, components of processing device 224, such as the PHY layer and MAC layer, are configured to operate in one or more of multiple bandwidth modes, such as 40 MHz, 80 MHz, 160 MHz, and 320 MHz. Accordingly, processing elements and/or firmware of processing device 224 are configured to select a high-bandwidth mode, and use the available bandwidth of the selected high-bandwidth mode to simultaneously scan multiple channels during scanning operations.

In various embodiments, the PHY layer is further configured to receive traffic from any channel, and not just a designated primary channel. In one example, such a designated primary channel may be a last used channel or a currently used channel. Thus, firmware included in processing device 224 is configured to enable the PHY layer to receive traffic from multiple channels in an agnostic manner independent of designations of primary channels. In this way, the PHY layer may be configured to simultaneously listen to multiple channels. In various embodiments, the MAC layer is also configured to be agnostic and operate independent of a designation of a primary band or channel. Moreover, the MAC layer may be configured to generate control signals controlling scanning operation timing and channel switching operations, as will be discussed in greater detail below.

In various embodiments, system 200 may include one or more other components configured to control scanning operations. For example, integrated circuit 220 or transceiver 202 may include hardware specifically configured to perform such scanning operations. Accordingly, transceiver 202 may include an integrated circuit specifically configured to generate control signals controlling scanning operation timing and channel switching operations disclosed herein. In some embodiments, programmable logic included in processing device 224 may be configured to scan through a list of channels based on detection/reception of beacon frames, as may occur during passive scanning, or transmission of probe request frames and subsequent reception of probe response, as may occur during active scanning. In this example, the programmable logic is configured to balance scan time and reliable discovery of any existing network/access point. In various embodiments, scan operations may be performed by a same radio chain with higher bandwidth, or may be performed by multiple radio chains independently configured to scan disjointed sets of channels by each independent link associated with a radio chain.

In another example, processor core block 210 may be configured to implement portions of an interface for a Bluetooth protocol using a Bluetooth stack in which software is implemented as a stack of layers, and such layers are configured to compartmentalize specific functions utilized to implement the Bluetooth communications protocol. In various embodiments, a host stack and a controller stack are implemented using at least processor core block 210. The host stack is configured to include layers for a Bluetooth network encapsulation protocol, radio frequency communication, service discovery protocol, as well as various other high-level data layers. The controller stack is configured to include a link management protocol, a host controller interface, a link layer which may be a low energy link layer, as well as various other timing layers.

System 200 further includes radio frequency (RF) circuit 221 which is coupled to one or more antennas, such as antenna 231, antenna 230, and antenna 232. In various embodiments, RF circuit 221 may include various components such as an RF switch, a diplexer, and a filter. Accordingly, RF circuit 221 may be configured to select an antenna for transmission/reception, and may be configured to provide coupling between the selected antenna, such as antenna 231, and other components of system 200 via a bus, such as bus 211. While FIG. 2 illustrates system 200 as having three antennas, it will be appreciated that system 200 may have a single antenna, or any suitable number of antennas.

System 200 includes memory system 208 which is configured to store one or more data values associated with channel scanning, as will be discussed in greater detail below. Moreover, memory system 208 may be configured to store computer program code executable by one or more processors. Accordingly, memory system 208 includes storage device, which may be a non-volatile random-access memory (NVRAM) configured to store such data values, and may also include a cache that is configured to provide a local cache. In various embodiments, system 200 further includes host processor 213 which is configured to implement processing operations implemented by system 200.

It will be appreciated that one or more of the above-described components may be implemented on a single chip, or on different chips. For example, transceiver 202 and processing device 224 may be implemented on the same integrated circuit chip, such as integrated circuit chip 220. In another example, transceiver 202 and processing device 224 may each be implemented on their own chip, and thus may be disposed separately as a multi-chip module or on a common substrate such as a printed circuit board (PCB). It will also be appreciated that components of system 200 may be implemented in the context of a low energy device, a smart device, or a vehicle such as an automobile. Accordingly, some components, such as integrated chip 220, may be implemented in a first location, while other components, such as antenna 231, may be implemented in second location, and coupling between the two may be implemented via a coupler such as RF coupler 222.

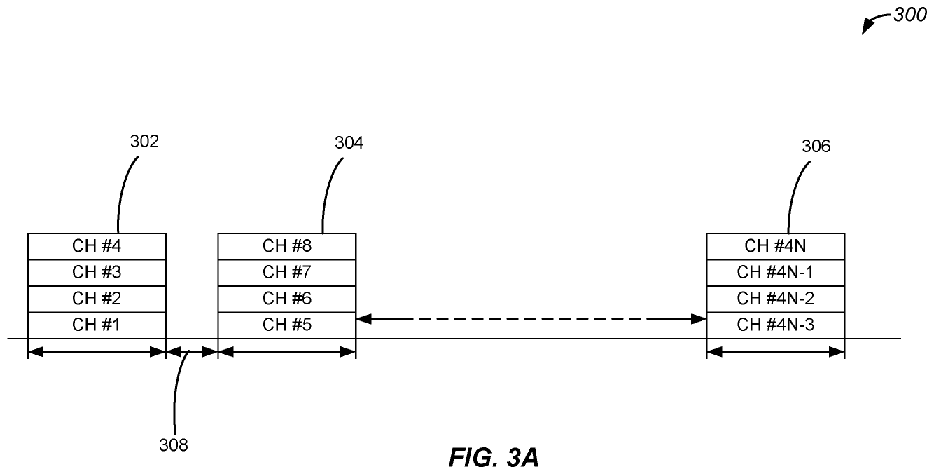

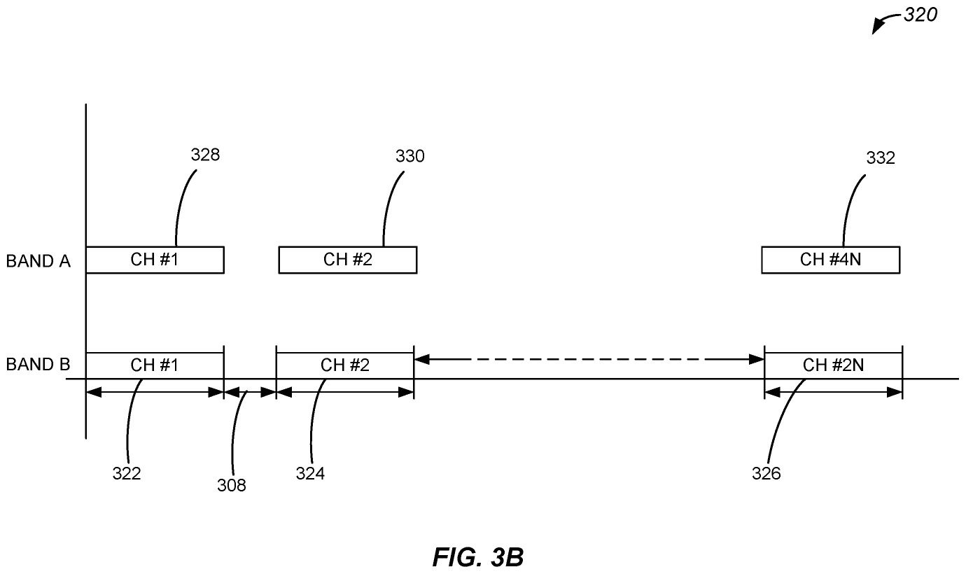

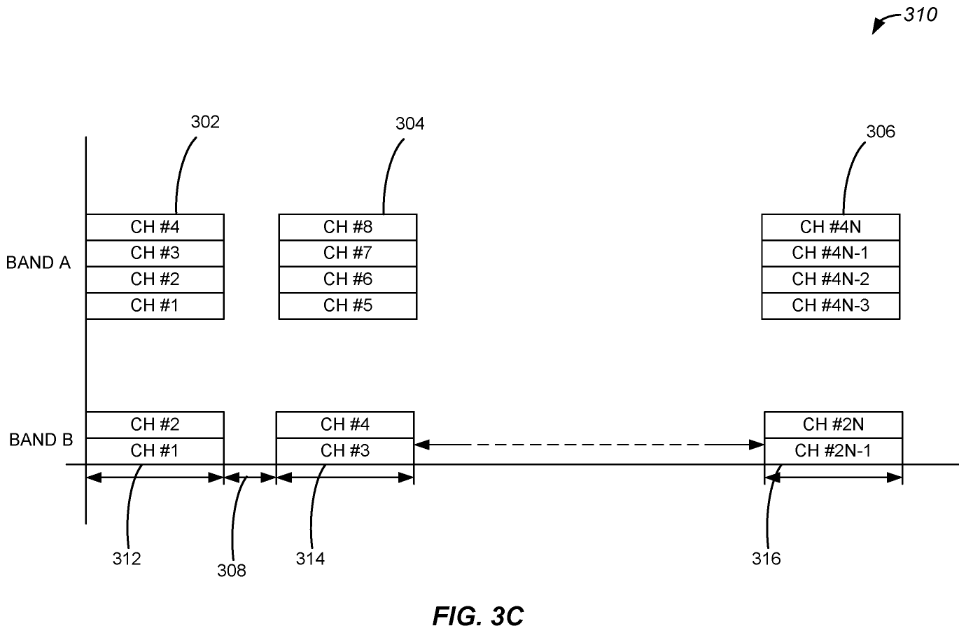

FIG. 3A illustrates an example of a timing diagram for channel scanning, implemented in accordance with some embodiments. As discussed above, scanning operations may be performed in parallel. Accordingly, timing diagram 300 illustrates how overall scan time of the channels is decreased by not scanning each channel serially, and reducing a number of channel switching operations in between scans. As will be discussed in greater detail below, a number of prob request frames used may also be reduced in an active scanning mode.

In various embodiments, timing diagram 300 includes scanning operations 302. As shown in timing diagram 300, scanning operations 302 show four channels being scanned at the same time. Accordingly, as discussed above, the PHY and MAC layer of a wireless device may be configured to simultaneously listen to channels 1 through 4, and determine if a transmission is received from an access point on any of those channels. As will be discussed in greater detail below, the number of channels scanned in parallel may be determined based, at least in part, on one of more bandwidth parameters. For example, in a high-bandwidth mode of operation, the wireless device may have an available bandwidth of 80 MHz. A bandwidth of each channel may be 20 MHz, as may be determined by parameters and specifications of a wireless communications protocol. Accordingly, dividing the available bandwidth by the size of a channel yields the ability to scan four channels at a time. While timing diagram 300 illustrates parallel scanning of four channels, it will be appreciated that any suitable number of channels may be scanned in parallel if supported by the available bandwidth of the wireless device.

Timing diagram 300 additionally includes switching operation 308 in which one or more components of the wireless device, such as the PHY layer, may be switched to scan additional channels. Accordingly, the wireless device may cycle through sets or groups of channels until all channels have been scanned. Accordingly, timing diagram 300 includes additional scanning operations, such as scanning operations 304 and scanning operations 306. As shown in FIG. 3, scanning operations 304 may concurrently scan channels 5 to 8, and scanning operations 306 may concurrently scan channels 4N-3 to 4N, where 4N is a maximum number of channels used by the wireless device associated with timing diagram 300. In this way, the wireless device may parallelize scanning of at least some of the channels to reduce an overall scan time associated with scanning all channels.

FIG. 3B illustrates an example of another timing diagram for channel scanning, implemented in accordance with some embodiments. As discussed above, scanning operations may be performed in parallel, and timing diagram 320 illustrates an additional example of how overall scan time of the channels may be decreased by scanning different bands of a wireless device in parallel, while channels of bands may be scanned serially. Accordingly, as shown in timing diagram 320, a first band may serially scan through its channels as shown by scanning operations 322, 324, and 326 which may have associated switching operations, such as switching operation 308. Moreover, a second band may serially scan through its channels as shown by scanning operations 328, 330, and 332. As shown in timing diagram 320, despite each band performing its respective scanning operations serially, the bands themselves may be scanned in parallel.

FIG. 3C illustrates an example of yet another timing diagram for channel scanning, implemented in accordance with some embodiments. As discussed above, scanning operations may be performed in parallel, and timing diagram 310 illustrates how overall scan time of the channels is decreased by not scanning each channel serially, and reducing a number of channel switching operations in between scans. As also shown in timing diagram 310 such parallel scanning operations may be performed for two different bands simultaneously.

As similarly discussed above, timing diagram 310 includes scanning operations 302, scanning operations 304, scanning operations 306, and switching operation 308. As shown in timing diagram 310, scanning operations 302, scanning operations 304, scanning operations 306, and switching operation 308 are performed for a first band of a wireless device. For example, as discussed above, the wireless device may have an available bandwidth of 80 MHz on the first band. A bandwidth of each channel may be 20 MHz, as may be determined by parameters and specifications of a wireless communications protocol.

In various embodiments, the wireless device may also support a second band. Accordingly, as shown in FIG. 3B, additional scanning operations 312, scanning operations 314, and scanning operations 316 may be performed for a second band of the wireless device. In this example, the wireless device may have a narrower bandwidth in second band than the bandwidth of the first band. In some embodiments, the first band may be scanned using a first transceiver of the wireless device, and the second band may be scanned using a second transceiver of the wireless device. In this way, multiple bands of the wireless device may be scanned simultaneously by using multiple collocated transceivers to perform scanning operations in parallel.

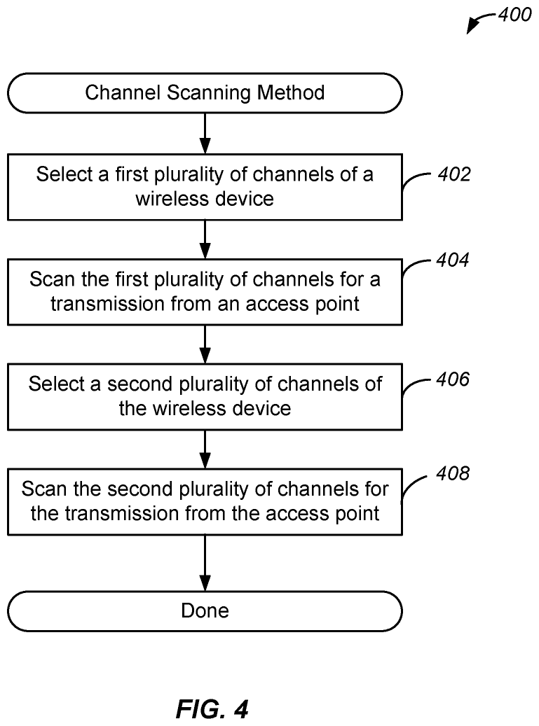

FIG. 4 illustrates an example of a method for channel scanning using wireless devices, implemented in accordance with some embodiments. As similarly discussed above, wireless devices may perform channel scanning operations in parallel. Accordingly, a method, such as method 400, may be performed to allocate available bandwidth to scan channels in parallel and reduce scan times associated with channel scanning and network discovery operations.

Method 400 may perform operation 402 during which a first plurality of channels may be selected. As similarly discussed above, a first group or set of channels of the wireless device may be selected based, at least in part, on an available bandwidth of the wireless device as well as a size of each channel. In some embodiments, the first plurality of channels is identified based on an order of channels and one or more channel identifiers.

Method 400 may perform operation 404 during which the first plurality of channels may be scanned for a transmission from an access point. In various embodiments, the first plurality of channels is scanned in parallel, and the wireless device may determine if a transmission is received from an access point on any of the first plurality of channels. As will be discussed in greater detail below, the first plurality of channels may be scanned actively or passively, and the transmission may be a probe response or a beacon frame.

Method 400 may perform operation 406 during which a second plurality of channels may be selected. As similarly discussed above, a second group or set of channels of the wireless device may be selected based, at least in part, on an available bandwidth of the wireless device as well as a size of each channel. In some embodiments, the second plurality of channels are identified based on an order of channels and one or more channel identifiers. More specifically, the second plurality of channels may be a subsequent group of channels identified based on a channel ordering.

Method 400 may perform operation 408 during which the second plurality of channels may be scanned for a transmission from the access point. In various embodiments, the second plurality of channels is scanned in parallel, and the wireless device may determine if a transmission is received from the access point on any of the second plurality of channels. As similarly discussed above, the second plurality of channels may be scanned actively or passively, and the transmission may be a probe response or a beacon frame.

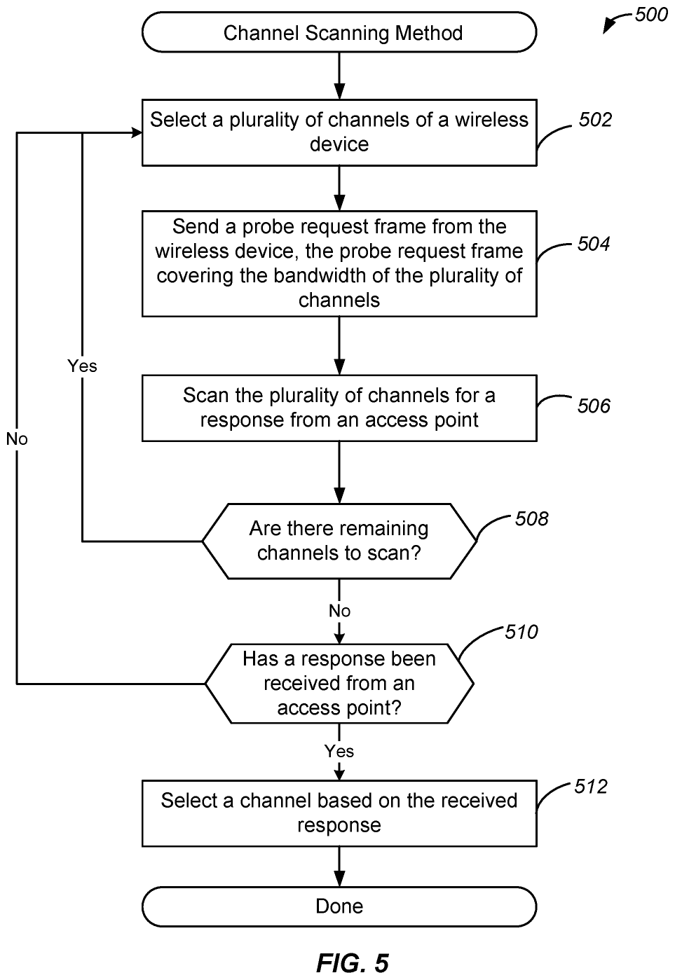

FIG. 5 illustrates an example of a method for channel scanning using wireless devices, implemented in accordance with some embodiments. As similarly discussed above, wireless devices may perform channel scanning operations in parallel. Accordingly, a method, such as method 500, may be performed to allocate available bandwidth to actively scan channels in parallel and reduce scan times associated with channel scanning and network discovery operations.

Method 500 may perform operation 502 during which a plurality of channels may be selected. As similarly discussed above, a group or set of channels of the wireless device may be selected based, at least in part, on an available bandwidth of the wireless device as well as a size of each channel. More specifically, a bandwidth available in a selected high-bandwidth mode may be partitioned by dividing the bandwidth by a size of a channel to identify a number of channels to be included in a group or set. In some embodiments, the available bandwidth may be less than the total bandwidth of the wireless device, and multiple sets or groups may be used, as will be discussed in greater detail below. In some embodiments, the set or group of channels is smaller than the total number of channels of the wireless device, and the plurality of channels is identified based on an order of channels and one or more channel identifiers.

Method 500 may perform operation 504 a probe request may be sent from a wireless device. Accordingly, the wireless device may be a station configured to use an active scanning mode to scan for a network connection and perform network connection operations with an access point. Accordingly, the wireless device may transmit a probe request frame in accordance with a Wi-Fi communications protocol during operation 504. It will be appreciated that a single probe request frame may be sent and used for all channels. In this way, transmission operations for multiple probe request frames are avoided, and overall scan time is reduced.

Method 500 may perform operation 506 during which the plurality of channels may be scanned for a transmission from an access point. In various embodiments, the plurality of channels is scanned in parallel, and the wireless device may determine if a transmission is received from an access point on any of the plurality of channels. In various embodiments, the transmission may be a response from the access point generated in response to the probe request frame. Accordingly, the transmission from the access point may be a probe request response.

Method 500 may perform operation 508 during which it may be determined if additional scanning operations should be performed. In various embodiments, such a determination may be made based on channel identifiers described above. For example, scanning may progress through scanning of groups of channels incrementally such that all channels, as identified by their identifiers which may be numbers, are scanned group by group. Thus, if all channels have been scanned and the wireless device has reached the end of a list of channels, it may be determined that no additional scanning operations should be performed. More specifically, if it is determined that additional channels remain and additional scanning operations should be performed, method 500 may return to operation 502. If it is determined that no additional channels remain and no additional scanning operations should be performed, method 500 may proceed to operation 510.

Accordingly, during operation 510, it may be determined if a response has been received from the access point. Accordingly, one or more components of the wireless device may observe signals received by the scanned channels, and may determine if a probe request response was received on any of the channels. If it is determined that no response has been received, method 500 may return to operation 502 to repeat scanning operations of the channels of the wireless device to continue scanning for an access point. If a response has been received, method 500 may proceed to operation 512.

Accordingly, during operation 512, a channel may be selected based on the received response. More specifically, the channel on which the response was received may be identified, and may be selected as an active channel for subsequent network connection and communication operations. In this way, the results of the parallel scanning operations may be used to identify and select a channel used for communication with the access point.

As discussed above with reference to FIGS. 3B and 3C, a wireless device may include multiple collocated transceivers, and may be configured to perform scanning operations of multiple bands in parallel. Accordingly, multiple iterations of method 500 may be performed in parallel for each respective transceiver. More specifically, an iteration of method 500 may be performed for a first transceiver operating on a first band, and a second iteration of method 500 may be performed in parallel for a second transceiver operating on a second band such that scanning operations for both bands are performed in parallel, as similarly discussed above with reference to FIGS. 3B and 3C.

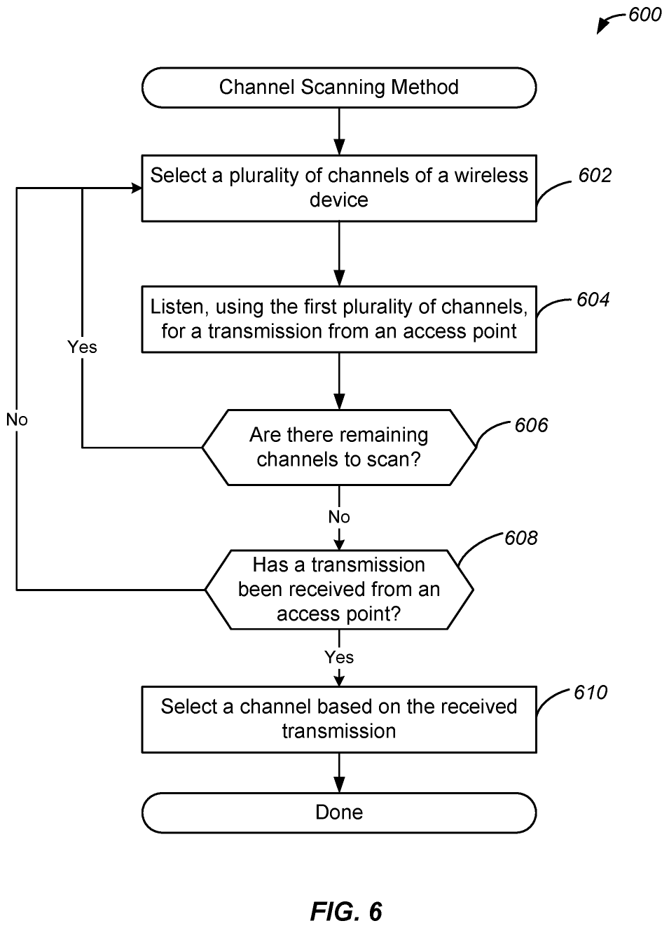

FIG. 6 illustrates an example of a method for channel scanning using wireless devices, implemented in accordance with some embodiments. As similarly discussed above, wireless devices may perform channel scanning operations in parallel. Accordingly, a method, such as method 600, may be performed to allocate available bandwidth to passively scan channels in parallel and reduce scan times associated with channel scanning and network discovery operations.

Method 600 may perform operation 602 which a plurality of channels may be selected. As similarly discussed above, a group or set of channels of the wireless device may be selected based, at least in part, on an available bandwidth of the wireless device as well as a size of each channel. More specifically, a bandwidth available in a selected high-bandwidth mode may be partitioned by dividing the bandwidth by a size of a channel to identify a number of channels to be included in a group or set. In some embodiments, the plurality of channels is identified based on an order of channels and one or more channel identifiers.

Method 600 may perform operation 604 during which the plurality of channels may be observed to listen for a transmission from an access point. In various embodiments, the plurality of channels is scanned in parallel, and the wireless device may determine if a transmission is received from an access point on any of the plurality of channels. In various embodiments, the transmission may be a beacon frame transmitted from the access point. Accordingly, the transmission from the access point may be a beacon frame periodically sent by the access point, and the wireless device may be configured as a station that uses a listening period to listen for such beacon frames.

Method 600 may perform operation 606 during which it may be determined if additional scanning operations should be performed. As similarly discussed above, such a determination may be made based on channel identifiers and tracking progression through a list of channels, as may be performed by a state machine. Accordingly, if it is determined that additional channels remain and additional scanning operations should be performed, method 600 may return to operation 602. If it is determined that no additional channels remain and no additional scanning operations should be performed, method 600 may proceed to operation 608.

Method 600 may perform operation 608 during which it may be determined if a transmission has been received from the access point. Accordingly, one or more components of the wireless device may observe signals received by the scanned channels, and may determine if a beacon frame was received on any of the channels. If it is determined that a transmission has not been received, method 600 may return to operation 602, and additional iterations of scanning operations may be performed. If a transmission has been received, method 600 may proceed to operation 610.

Accordingly, during operation 610, a channel may be selected based on the received transmission. More specifically, the channel on which the beacon frame was received may be identified, and may be selected as an active channel for subsequent network connection and communication operations. In this way, the results of the parallel scanning operations may be used to identify and select a channel used for communication with the access point.

As similarly discussed above, a wireless device may include multiple collocated transceivers, and may be configured to perform scanning operations of multiple bands in parallel. Accordingly, multiple iterations of method 600 may be performed in parallel for each respective transceiver and its associated band. More specifically, an iteration of method 600 may be performed for a first transceiver operating on a first band, and a second iteration of method 600 may be performed in parallel for a second transceiver operating on a second band such that scanning operations for both bands are performed in parallel.

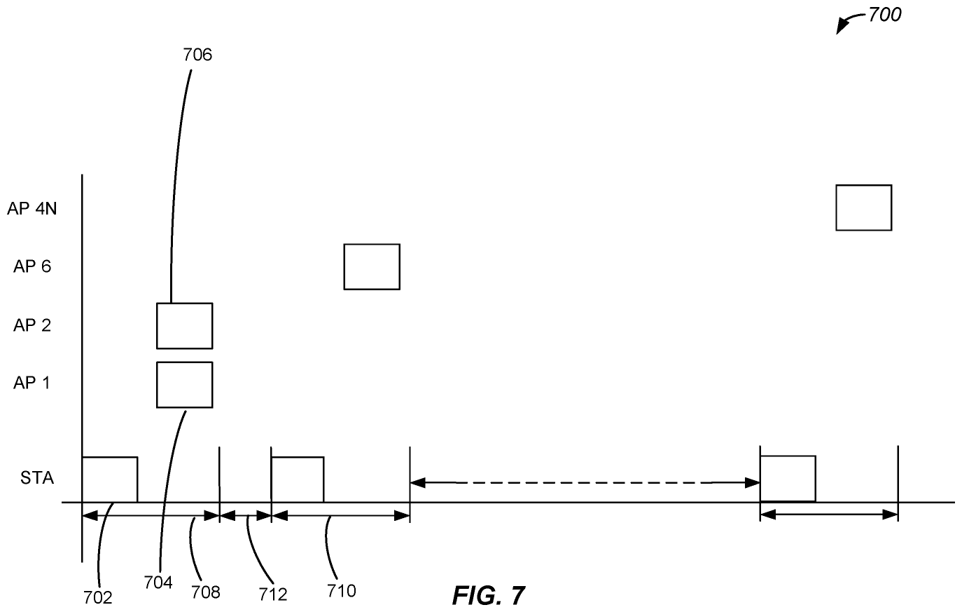

FIG. 7 illustrates an example of a timing diagram for active channel scanning, implemented in accordance with some embodiments. As shown in timing diagram 700, during a set of scanning operations, such as scanning operations 708, a probe request frame, such as probe request frame 702, may be sent by a station. As discussed above, the set of scanning operations may be for a first set of channels, and an additional set of scanning operations, such as scanning operations 710, may be for a second set of channels. Moreover, there may be a period of time for switching operations 712 to switch channels. Furthermore, probe request frame 702 may be sent across the bandwidth used by scanning operations 708 such that a single probe request frame is transmitted across all channels scanned during scanning operations 708.

In various embodiments, multiple access points may be within communication range of the station, and may send probe response frames. Accordingly, as also shown in timing diagram 700, multiple probe response frames may be received from various access points. Moreover, probe response frames may be received in parallel. For example, probe response frame 704 may be received from first access point and probe response frame 706 may be received from a second access point. As shown in timing diagram 700, probe response frame 704 and probe response frame 706 are received in parallel and during the same set of scanning operations. In this way, probe response frames may be received and processed in parallel, and do not need to be received serially.

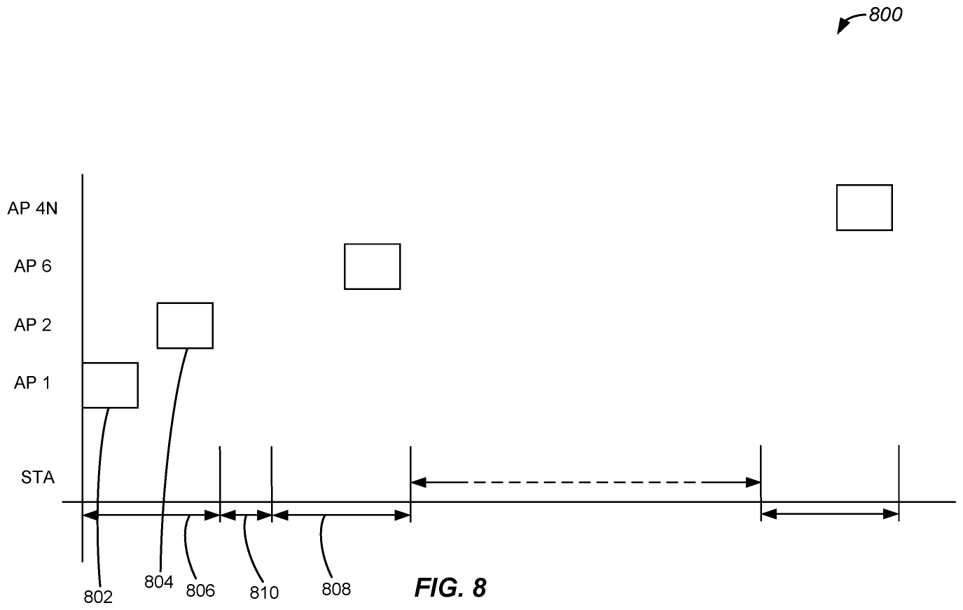

FIG. 8 illustrates an example of another timing diagram for passive channel scanning, implemented in accordance with some embodiments. As shown in timing diagram 800, during a set of scanning operations, a beacon frame, such as beacon frame 802, may be received by a station. As similarly discussed above, different sets of scanning operations, such as scanning operations 806 and scanning operations 808, may be used for different groups of channels. Moreover, there may be a period of time for switching operations 810 to switch channels. As also discussed above, multiple access points may be within communication range of the station, and may send beacon frames. Accordingly, as also shown in timing diagram 800, multiple beacon frames may be received from various access points. Moreover, multiple beacon frames may be received while several channels are being scanned in parallel. For example, beacon frame 802 may be received from a first access point and beacon frame 804 may be received from a second access point. As shown in timing diagram 800, beacon frame 802 and beacon frame 804 are received during parallel scanning of the same set of channels in scanning operations 806. In this way, beacon frames may be received and processed in parallel, and do not need to be received serially.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
selecting a first plurality of channels of a wireless device, the first plurality of channels being sub-bands of a wireless device;
scanning the first plurality of channels for a transmission from an access point, the first plurality of channels being scanned in parallel;
selecting a second plurality of channels of the wireless device, the second plurality of channels being sub-bands of the wireless device; and
scanning the second plurality of channels for the transmission from the access point, the second plurality of channels being scanned in parallel.

2. The method of claim 1, wherein the first plurality of channels different from the second plurality of channels.

3. The method of claim 1, wherein the first plurality of channels is used by a first transceiver operating on a first band, and wherein the second plurality of channels is used by a second transceiver operating on a second band.

4. The method of claim 1 further comprising:
sending a probe request frame from the wireless device, wherein the transmission from the access point is a response to the probe request frame.

5. The method of claim 1, wherein the transmission from the access point is a beacon frame.

6. The method of claim 1, wherein a first number of the first plurality of channels and a second number of the second plurality of channels are determined based, at least in part, on a bandwidth of the wireless device.

7. The method of claim 6, wherein the first number and the second number are determined dividing the bandwidth of the wireless device by a size of a channel.

8. The method of claim 1, wherein the wireless device is multi-band device.

9. The method of claim 8, wherein the multi-band device is a tri-band device.

10. A device comprising:
a memory configured to store channel information associated with channels of a wireless device; and
processing elements configured to:
select a first plurality of channels of the wireless device, the first plurality of channels being sub-bands of the wireless device;
scan the first plurality of channels for a transmission from an access point, the first plurality of channels being scanned in parallel;
select a second plurality of channels of the wireless device, the second plurality of channels being sub-bands of the wireless device; and
scan the second plurality of channels for the transmission from the access point, the second plurality of channels being scanned in parallel.

11. The device of claim 10, wherein the first plurality of channels is used by a first transceiver configured to operate on a first band, and wherein the second plurality of channels is used by a second transceiver configured to operate on a second band.

12. The device of claim 10, wherein the processing elements are further configured to:
send a probe request frame from the wireless device, wherein the transmission from the access point is a response to the probe request frame.

13. The device of claim 10, wherein the transmission from the access point is a beacon frame.

14. The device of claim 10, wherein a first number of the first plurality of channels and a second number of the second plurality of channels are determined based, at least in part, on a bandwidth of the wireless device.

15. The device of claim 14, wherein the first number and the second number are determined dividing the bandwidth of the wireless device by a size of a channel.

16. A system comprising:
an antenna configured to transmit and receive wireless signals;
a transceiver coupled to the antenna;
a memory configured to store channel information associated with channels of a wireless device; and
processing elements configured to:
select a first plurality of channels of the wireless device, the first plurality of channels being sub-bands of the wireless device;
scan the first plurality of channels for a transmission from an access point, the first plurality of channels being scanned in parallel;
select a second plurality of channels of the wireless device, the second plurality of channels being sub-bands of the wireless device; and
scan the second plurality of channels for the transmission from the access point, the second plurality of channels being scanned in parallel.

17. The system of claim 16, wherein the first plurality of channels is used by a first transceiver operating on a first band, and wherein the second plurality of channels is used by a second transceiver operating on a second band.

18. The system of claim 16, wherein the processing elements are further configured to:
send a probe request frame from the wireless device, wherein the transmission from the access point is a response to the probe request frame.

19. The system of claim 16, wherein the transmission from the access point is a beacon frame.

20. The system of claim 16, wherein a first number of the first plurality of channels and a second number of the second plurality of channels are determined based, at least in part, on a bandwidth of the wireless device, and wherein the first number and the second number are determined dividing the bandwidth of the wireless device by a size of a channel.
